(19) United States
(12) Patent Application Publication
(10) Pub. No.: US 2020/0100445 A1
(43) Pub. Date: Apr. 2, 2020

(54) CONFIGURABLE CONTROLLED-ENVIRONMENT AGRICULTURE SYSTEM

(71) Applicant: Simon E. Saba, San Jose, CA (US)

(72) Inventor: Simon E. Saba, San Jose, CA (US)

(21) Appl. No.: 16/147,679

(22) Filed: Sep. 29, 2018

(51) Int. Cl. A01G 31/04; G06F 7/00; A01M 7/00

(52) U.S. Cl. CPC A01G 31/04; A01F 25/00; A01M 7/0089; G06F 7/00

(57) ABSTRACT

An apparatus, system, and method for controlled-environment agriculture, including a closed-loop conveyor for transporting at least one container housing one or more plants to static or locally moveable service station(s) delivering at least one service in a sequential manner to plants on the conveyor and in parallel with other service stations for other services. A transition section conveys plants between an illuminated zone and a dark zone on FIFO basis. The conveyor cycle is computer programmable on a plant-by-plant basis for i) service station frequency and duration; and ii) illuminated zone/dark zone duty cycles for desired growth pattern and conveyor path routing based on sensor input to database. Different plant types at different growth stages are ‘interleaved’ on a same compact system (sensors, conveyor, and service stations) using artificial intelligence, deep learning, and computer vision for wide plant variety inventory management and programmed selective harvesting.

### FIELD OF TECHNOLOGY

This disclosure relates generally to the technical fields of agriculture and in one example embodiment, this disclosure relates to a method, apparatus and system of controlled-environment agriculture.

### BACKGROUND

Controlled-environment agriculture (CEA) has been a proposed solution for years to increase agricultural output for solving world-hunger, and to reduce produce transportation costs, and pesticide, fungicide, herbicide (Xcide) usage. For example vertical farming was introduced in the early 1900s and mixed-use skyscrapers introduced in the 2000s. Various environmental benefits arise from CEA, such as reduction in water consumption, increase in quantity of harvesting cycles, reduced embodied energy, and less pollution.

If a CEA system provides light and plumbing infrastructure throughout the entire cultivating space for plants, such that each plant receives a controlled provision of both light and water, as well as other services, local to the plant, then the result is a large, sophisticated, and costly infrastructure for operation and maintenance. Much of the time, these resources are not used, thereby resulting in a low duty cycle. For example, watering applications are used only in a small percentage of the total twenty-four hour period. However, to provide plumbing infrastructure and maintenance support to every plant location is costly. Lighting application might also be limited to only a fraction of the day. It is possible, but rare that an ‘always on’ condition exists (i.e., one-hundred percent of the time illumination for extended days, for specialized application).

Additionally, a typical CEA facility houses a large quantity of a single type of crop at a homogenous life stage. Thus, a crop of plants (being one type of a vegetable, herb, fruit, flower, etc.) typically start as seedlings at the start of the entire crop at the CEAS and grow to maturity for mass harvest of the entire crop at once. This methodology is convenient for high-demand plants, but can result in a spike in production output and distribution resources. That is, where a large quantity of the given type of fruit, vegetable, flowers or plants is harvested at one time, a concentrated effort in harvesting, processing, and transportation to distributed markets at possibly distant locations is required. Furthermore, this methodology of growing produces little variety in types of plants and stages of plant growth for a given facility. This method typically results in nearly homogenous crop performance, with outliers and problem plants being easy to detect in a field having the exact same plant in the exact same growth stage.

In contrast, assembly lines for machines or parts are not comparable to cultivation of plants. The latter require repeated maintenance and evaluation through a growth stage involving repeated days', weeks', or months' worth of incubation within a growth facility. The former are assembled and shipped as a onetime operation. Mechanical parts and electrical assemblies on the other hand can be metal, plastic, ceramic, etc. parts that traverse an assembly line typically only once, for one or more serial operations for finishing, assembly, and packaging. For example, a sedan is not nurtured and re-routed through a car assembly plant repeatedly to see how it grows. Instead, it is assembled as quickly and efficiently as possible and shipped.

### SUMMARY

An apparatus, system, and method for agricultural plant-growing, including a conveyor for transporting at least one container housing one or more plants; and at least one service-station for delivering at least one service to each of the one or more plants in the at least one container. The at least one service delivered by the at least one service-station is provided in at least one of i) a sequential manner vis-à-vis another container disposed on the conveyor and ii) a parallel manner with at least one other service-station disposed on the conveyor. The plurality of service-stations in the system provide one or more service of a watering service-station, a photo service-station, a measuring service-station, a chemical application service-system, a fertilizer service-station, a pruning service-station, a weighing service-station, a gas analyzer service-station, a gas spectroscopy service-station, a gender-detecting service-station, a seed-detection service-station, a fruit detection service-station, an elasticity testing service-station, a computer-vision service-station, an extraction service-station, a harvesting service-station, and other stations that provide metrics and growth status and control. The service station can be static or a locally moveable fixture (e.g., not moving beyond a next station on a conveyor). The at least one container passes through the station to receive a service provided by the station.

The agricultural plant-growing system also includes a transition section coupled to the conveyor, wherein the transition section separates an illuminated zone from a dark zone. The illuminated zone is illuminated and the darkened zone is darkened continuously for at least one of a nursery growth stage, a maturation growth stage, and a harvesting growth stage. Plants are conveyed through the illuminated zone and the dark zone on a first-in-first-out (FIFO) basis via the transition section. The transition section is a door system in one embodiment, and in one specific embodiment, it is a revolving door that enables the transport of plant containers from the illuminated zone, or area, to the darkened zone, or area, while preventing all effective light (<5% light) from passing therebetween that would otherwise disturb a growing cycle of a given type of the one or more plants that is sensitive to light for at least a given period of time. If even a flash of light enters a darkened zone for plants sensitive to light for that period of their growth cycle, it could ruin the batch of plants.

The continuous conveyor cycle is programmable to create any duty cycle of time for exposing the plant containers to different lengths of time in illuminated and dark zones to represent different seasons of a year and for a desired growth pattern. The conveyor is a closed loop conveyor with a complete cycle representing a pattern of at least one light cycle and one dark cycle for plant growth. The duration of time for the complete cycle can change over a growth lifespan of a given plant. The complete cycle is a programmable length of time, greater than or less than a 24-hour day, e.g., a 26-hour light and 10-hour dark cycle, or an 8-hour light and 3-hour dark cycle. The duty cycle is one of a synchronous, asynchronous, cyclic, continuous, and intermittent duty cycle. The conveyor can run a variable duty cycle for at least one of the one or more plants disposed in the illuminated zone and/or darkened zone. It can operate in any combination of intermittently stopped and/or continuously moving pattern for at least one of the one or more plants disposed in the illuminated zone and in the darkened zone.

The system includes at least one sensor coupled to the at least one service station. The at least one sensor senses at least one of a unique identifier of the one or more plants, a visual condition of the one or more plants, a weight of the one or more plants, an elasticity of the one or more plants, a health condition of the one or more plants, a chemical effusion of the one or more plants, a reflectivity of the one or more plants, and other metrics.

A database memory is employed to receive the input from the one or more sensors from at least one of the one or more plants. A processor coupled to the memory instructs the at least one of the service stations to deliver a plant-specific service depending upon data received from the one or more sensors. The sensor data combined with the computer-controlled management of the plants at each service station and in the illuminated and dark zones is programmable on a plant-by-plant basis.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. Furthermore, the methods, operations, processes, systems, and apparatuses disclosed herein may be implemented in any means for achieving various aspects, and may be executed in a form of a machine-readable medium, and/or a machine accessible medium, embodying a set of instructions that, when executed by a machine or a data processing system (e.g., a computer system), in one or more different sequences, cause the machine to perform any of the operations disclosed herein. Other features will be apparent from the accompanying drawings and from the detailed description that follows. Accordingly, the specification and drawings are to be regarded in an illustrative rather than a restrictive sense.

### BRIEF DESCRIPTION OF THE VIEW OF DRAWINGS

Example embodiments are illustrated by way of example and not limitation in the figures of the accompanying drawings, in which like references indicate similar elements and in which:

FIG. 1A is a floor plan of a conveyor-system for growing plants in a controlled-environment agriculture system, according to one or more embodiments.

FIG. 1B is an isometric view of the exterior of the facility for controlled-environment agriculture system, according to one or more embodiments.

FIG. 1C is an isometric view of the exterior of the facility for controlled-environment agriculture system utilizing 3D space, according to one or more embodiments.

FIG. 2A is a water service station of a controlled-environment agriculture facility, according to one or more embodiments.

FIG. 2B is a computer vision service station of a controlled-environment agriculture facility, according to one or more embodiments.

FIG. 2C is a weight-measurement service station of a controlled-environment agriculture facility, according to one or more embodiments.

FIG. 2D is a floor plan of a cart-system for growing plants in a controlled-environment agriculture system, according to one or more embodiments.

FIGS. 2E-2F are floor plans of a cart-system for growing plants in a controlled-environment agriculture system with labyrinth doors for transition between dark and illuminated zones, according to one or more embodiments.

FIG. 3 is a mobile device for receiving data and transmitting instructions to a controlled-environment agriculture facility, according to one or more embodiments.

FIG. 4 is a computing system for receiving data and transmitting instructions to a controlled-environment agriculture facility, according to one or more embodiments.

FIG. 5A is a method for servicing plants and managing time cycles in light and dark zones in a controlled-environment agriculture facility, according to one or more embodiments.

FIG. 5B is a method for controlling, data gathering, and providing feedback to improve plant growth in a controlled-environment agriculture facility, according to one or more embodiments.

Other features of the present embodiments will be apparent from the accompanying drawings and from the detailed description that follows.

### DETAILED DESCRIPTION

A method, apparatus and system for controlled-environment agriculture is disclosed. In the following description, for the purposes of explanation, numerous specific details are set forth in order to provide a thorough understanding of the various embodiments. However, it will be evident that one skilled in the art may practice various embodiments within the scope of this disclosure without these specific details.

### Floor Plan

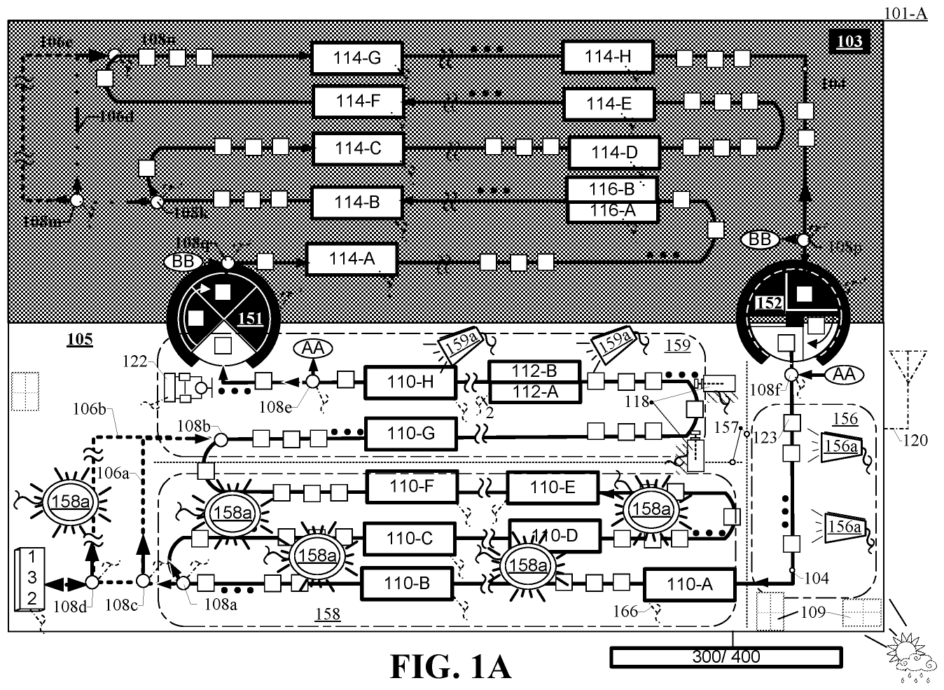

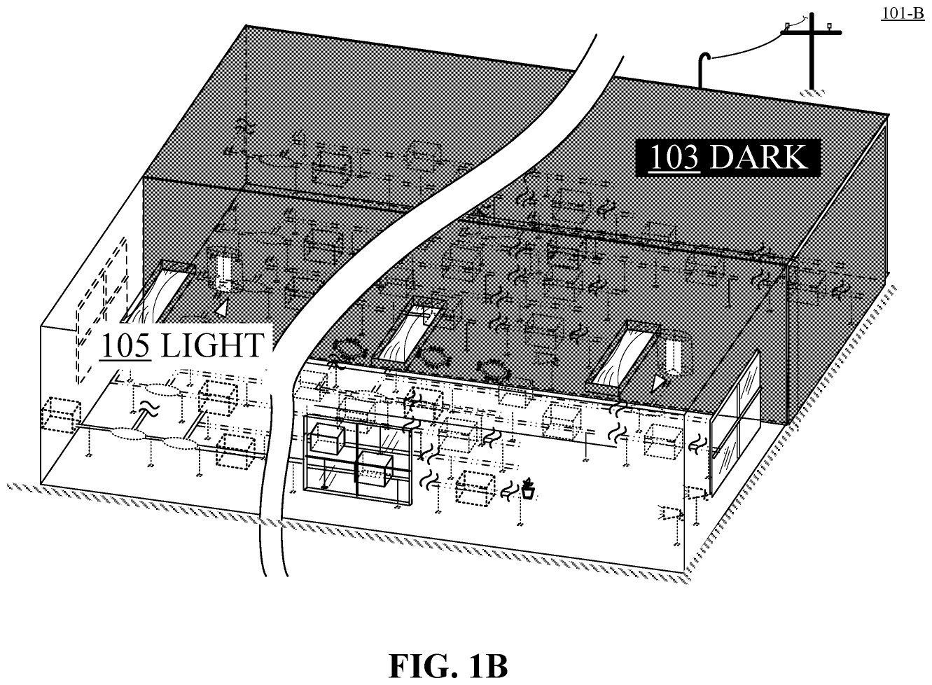

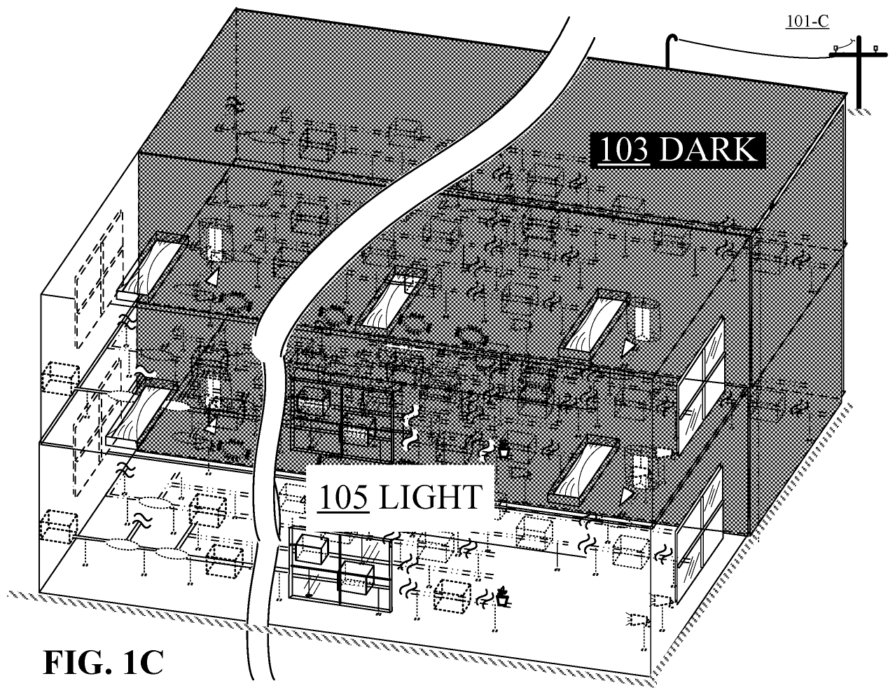

Referring now to FIG. 1A, a floor plan is shown of a controlled-environment agriculture system (CEAS) 101 for growing plants, according to one or more embodiments. The CEAS 101 comprises i) a mover, e.g., conveyor 104, for transporting at least one container 123 housing one or more plants; and at least one service station 110-A to 110-H, 112-A to 112-B, 114-A to 114-H, and 116-A to 116-B for delivering at least one service to each of the one or more plants in container 123. However, a given service station in the present embodiment is not capable of delivering a service simultaneously to all the plants in CEAS 101 or in a given zone, 103 (dark), or 105 (light). For example, an illumination service is not available for all plants in CEAS, but is restricted to only illumination zone 105; and water service is provided by one or more stations in zones 103, 105, but is not able and not required to deliver water simultaneously to every plant in CEAS 101. This reduces infrastructure and maintenance cost and resources, and provides at least a single point application of services that can be tuned and plant-specific. The at least one service delivered by the at least one service station is provided in at least one of i) a sequential manner to another container disposed on conveyor 104 and ii) a parallel manner with at least one other service station disposed on the conveyor 104. For example, most service stations are single stations with only one installation, e.g., 110-A to 110-H, and 114-A to 114-H. However, other service station embodiments have a plurality of repeated stations in parallel, such as 112-A to 112-B and 116-A to 116-B, because the station speed is less than the line speed (integer quantity X of stations=[conveyor speed/station speed]). Alternatively, conveyor speed or indexing rate is specified by the service station with the longest cycle time. In another embodiment, parallel service stations, e.g., 112-A, 112-B, both deliver a service, e.g., water, but in different methods, e.g., spray vs. hose watering as suited for different plant types or growth stages. Duplicate stations can also be used as a backup station offering the same service as the main station, so the main station can be maintained and repaired without interrupting the conveyor speed or throughput. While the floor plan shown is a top down view in the present embodiment, thus representing a single floor of a building or container, in another embodiment, diagram 101 is a side view of a multi-level facility (within a given single or multiple stories of a building or container). For example, a light zone 105 is a floor plan in one level, while the transition sections 151, 152 transfer the containers and plants to a floor plan on a higher or lower level. Alternatively, if crops are typically within a given height for a given range of plants, and growing regimens serviced by the CEAS, then multiple levels of movers and plants can be accommodated within a given height room. For example, if a standard building has a 20-foot ceiling, then conveyors can be stacked upon each other, or carts can have multiple levels on the single wheeled base. Service stations can exist at each of the levels to provide the necessary service. To accommodate multiple levels of plants, lighting can be provided from a wide variety of sources and angles. For example, lighting can be provided from side-mounted, bottom-mounted and ceiling mounted artificial light sources, as well as from natural light sources from windows on top, bottom, and sides of the room structure. Lighting can also be provided from interspersed lights between layers of conveyors, or between levels of a cart, wherein electrical service is provided along the conveyor or along a cart's track.

The at least one service station 110-A to 110-H, 112-A to 112-B, 114-A to 114-H, and 116-A to 116-B comprises at least one of: a watering service station, a photo service station, a measuring service station, a chemical application service station (pesticide, herbicide, fungicide, etc.), a fertilizer service station, a pruning service station, a weighing service station, a gas analyzer service station, a gas spectroscopy service station, a gender-sensing service station, a seed-detection service station, a fruit detection service station, an elasticity testing service station, a computer-vision service station, an extraction service station, a harvesting service-station, and any other service required for growing, maintaining, blooming, fruiting, and harvesting the plants. An elasticity service station can test hydration and general health of a plant by the plant's response to an input, either a jerk motion on conveyor (stop or start), or a probe that selectively taps a plant. The response can be measured in terms of quantity, frequency and amplitude of a plant's oscillating movement as captured by a service station with computer vision or photocell detector(s), whose beam is broken by a passing object, namely part of the plant. Any means for delivering services necessary for cultivating plants is contemplated herein, where said means includes any infrastructure to supply consumables dispensed by said service, a means for identifying a given plant in order to tailor the service to the status of the plant, and at least one of mechanical, electrical, and chemical apparatus appropriate to deliver said service. The specific function of each of service stations 110-A to 110-H, 112-A to 112-B, 114-A to 114-H, and 116-A to 116-B depends upon the application, with the user free to configure repeat service stations, or unique service station sequencing, etc. The point is that the line is configurable per a given (superset of plants) application needs, based on at least the list of given functions above. In one embodiment, multiple functions can be coupled in a modular form to the extent they are compatible, and sequenced in a proper manner to avoid self-defeating interference of services (e.g., a watering function immediately after an application of pesticide, which would cause the pesticide to be washed away, etc.).

Referring now to FIG. 1C, an isometric view is shown of the exterior of the facility for controlled-environment agriculture system utilizing 3D space, according to one or more embodiments. FIG. 1C is essentially the system of FIG. 1B, but stacked, either with an intermediate (false) floor, or with stacked steel support infrastructure for a conveyor system that rises up to take advantage of the full volume of space available in a given building, container (sea container), etc. Lighting is provided from the sides, the top, and the bottom to reach all plants as evenly as possible. Elevated walkways allow maintenance access to second layer. Alternatively, conveyor track travels through both the top and bottom track for the entire route, so that every plant passes through the bottom level, for human intervention or evaluation, as required, at a convenient floor level.

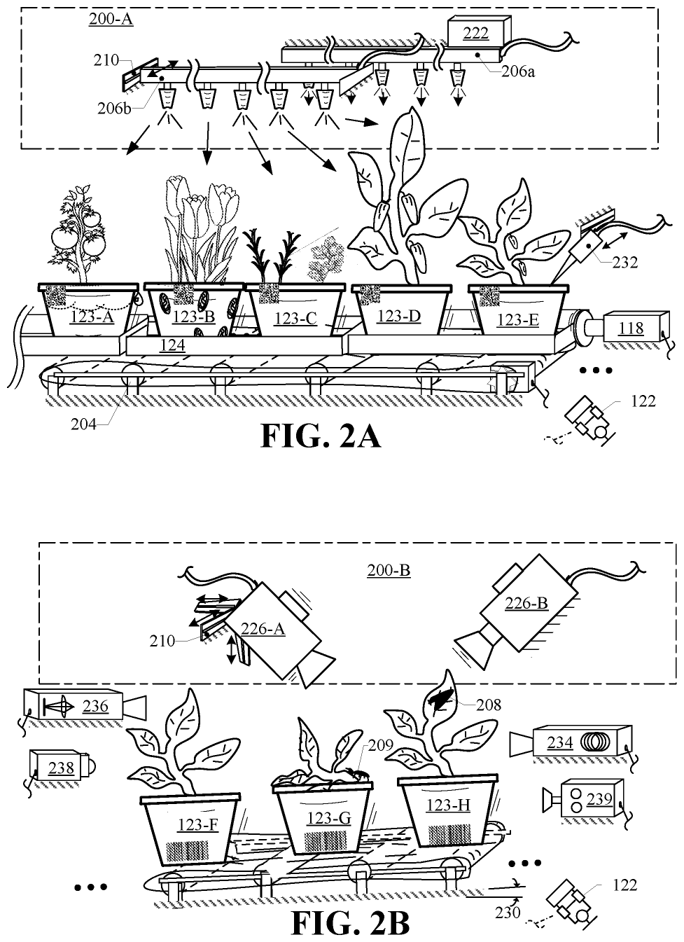

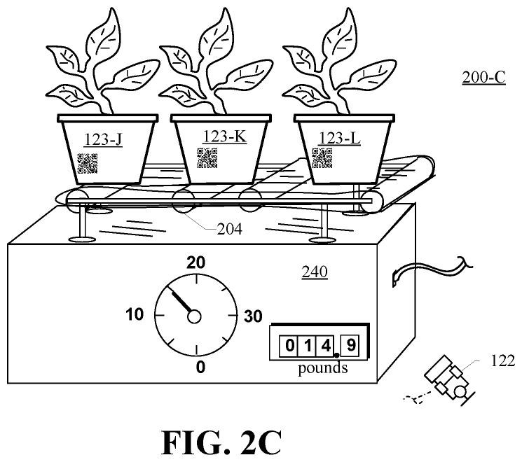

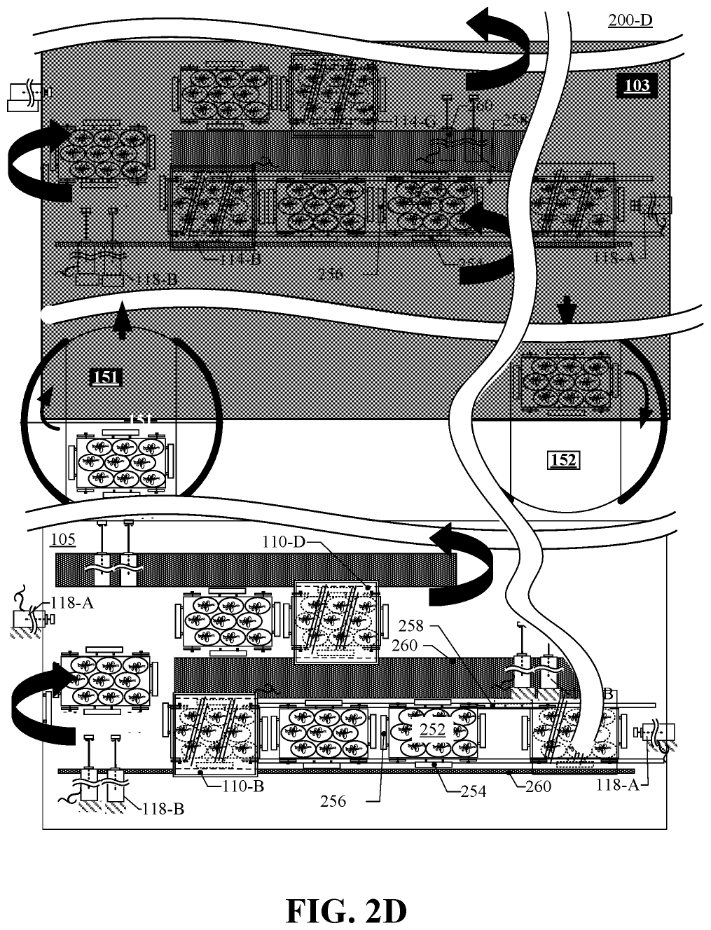

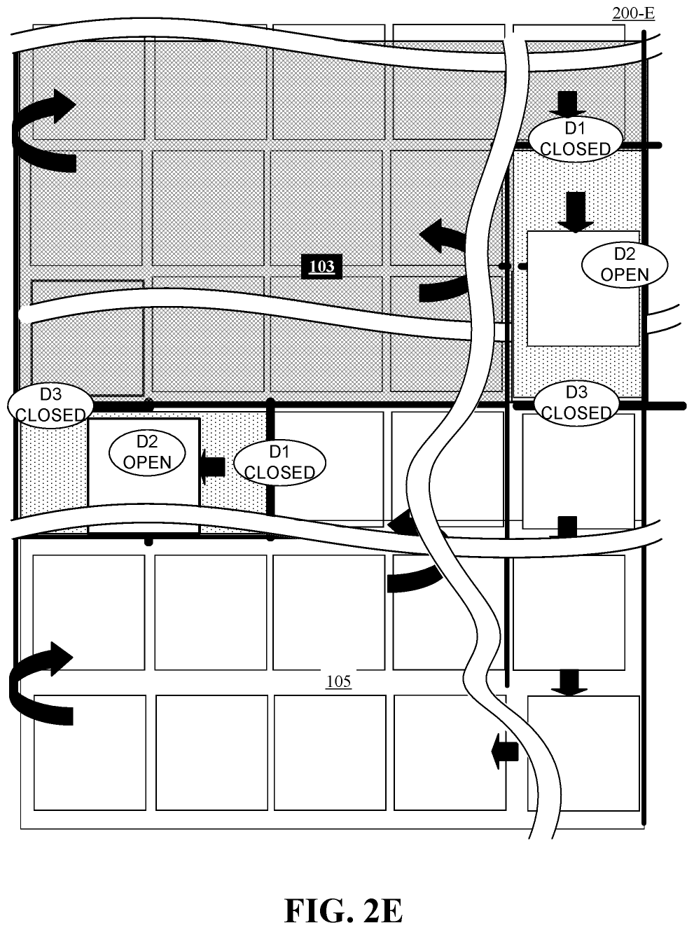

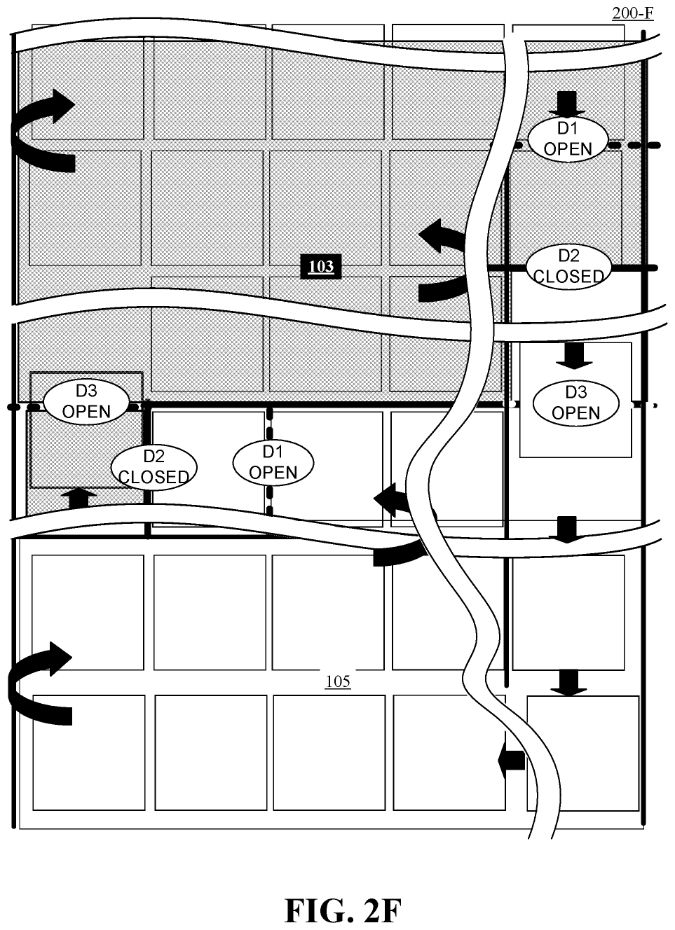

The service station is at least one of a static and a locally moveable fixture, (e.g., see FIG. 2A) wherein the at least one container passes through, or stops at, the station to receive a service provided by the station. For service station 110-A, every container 123 passes therethrough to reach the next station, e.g., 110-B, etc. Alternatively, a station bypass (not shown) can bypass a service if programmed to do so, because the service is not mandatory for a given type of crop. Alternatively, the service can be withheld as the plant passes therethrough. The granularity of delivery of a service can be as specific as a single plant at a time, given the ID system that identifies each plant in a container 123, and the station modularity.

In the present embodiment, service stations 110-A to 110-H, 112-A to 112-B, 114-A to 114-H, and 116-A to 116-B operate in parallel with each other, in the sense that when service station 110-A is delivering a service to at least one given container (with one or more plants), a different service station, e.g., 110-B is likewise delivering its service to an upstream at least one other container (with one or more of the same or different plants) simultaneously. Conveyor 104 moves container 123 with plant(s) at a smooth continuous speed through each service station 110-A to 110-H, 112-A to 112-B, 114-A to 114-H, and 116-A to 116-B, with delivery provided as the plant moves therethrough. Service stations 110-A to 110-H, 112-A to 112-B, 114-A to 114-H, and 116-A to 116-B are either static or locally moveable to travel along a portion of conveyor 104 at a same rate, or a programmable fraction of a rate (between 20-50%, 20-80%, and 20-100%) of a passing container 123 with plant(s), then quickly retract back to a home position to service the next plant. Service stations contain a quantity of service-delivery components (water, pesticides, fertilizer, etc.), or a rate of delivering said service-delivery components as continuously supplied that meets or exceeds a highest-service plant accepted into CEAS 101 (e.g., the largest, most mature, and most resource intensive plant serviced). Alternatively, conveyor 104 can be stepped, or indexed, with plants stopping at different service stations for service.

CEAS 101 also includes one or more transition sections 151, 152 coupled to the conveyor 104, wherein the transition section separates an illuminated zone 105 from a dark zone 103. The transition section 151, 152 prevents all effective light from passing therethrough that would otherwise disturb a growing cycle of a given type of the one or more plants that is sensitive to light for at least a given period of time. In one embodiment, each transition section is dedicated to a one-way transition between zones. For example, one transition section 151 is for transferring plants from a light zone 105 to a dark zone 103, while the other transition section 152 is for transferring plants from a dark zone 103 to a light zone 105. In another embodiment, the transition sections can be bidirectional, if timed and positioned accordingly, to move a plant from one section to the other, and when empty, receive a plant going in the opposite direction. Multiple transition sections 151, 152 can be used for either direction (dark to light or vice versa) if higher rates of transition are needed to match a speed or indexing rate of conveyor 104.

In the present embodiment, illuminated zone 105 is illuminated continuously, while darkened zone 103 is dark (darkened) continuously, where the term continuously is at least one of a nursery growth stage, a maturation growth stage, and a harvesting growth stage. Thus, for a life of a given crop (a new batch of seeds, seedlings, etc.), said zones will remain in their given state of illuminated or darkened. Containers 123 with plants are moved by conveyor 104 into the illuminated zone 105 and into the darkened zone 103 on a first-in-first-out (FIFO) basis in one embodiment. The darkened zone is a blackout area with less than 10%, 5%, or 1% of light (detectable to a given plant being cultivated, i.e., phyto-detectable), whether it be natural or artificial light, and whether the transition section 151, 152 be in a dynamic or static state. In the present embodiment, transition sections 151, 152 are each a revolving door that transports plant containers 123 between the illuminated zone 105 and the darkened zone 103 and that prevents more than 5% light passage from the illuminated area to the darkened area. Maintaining a controlled illumination or darkened environment in separate zones beneficially keeps plants in a given maturation/growth stage, or moves plants into a different growth stage, depending on the type of plant. In another embodiment, containers 123 with plants are moved into the darkened zone 105 on a basis other than FIFO, e.g., on a last-in-first-out (LIFO) basis in order to skew the time that each plant sustains in the darkened zone 103, for an intentional skewed distribution of light or darkness duration for growth or maturation purposes.

Conveyor 104 is programmable, or configurable, for speed and routing to represent different light and dark duty cycles desired, e.g., to represent different seasons of a year. A continuous conveyor cycle is programmable to represent any duty cycle 304 of time for exposing the plant containers to light and darkness for a desired growth/maturation pattern. Conveyor 104 is a closed loop with a complete cycle to represent at least a pattern of at least one light cycle and one dark cycle for plant growth (e.g., a day and night cycle). The duration of time for the complete cycle can change over a growth lifespan of a given plant. The complete cycle is a programmable length of time, greater than or less than a 24-hour day. Thus, different plants in CEAS 101 can simultaneously receive i) multiple day/night cycles within a given 24 hour period, or ii) a cycle greater than 24 hour period. The duty cycle is one or more of a synchronous, asynchronous, cyclic, continuous, and/or intermittent duty cycles. In one example, if a plant transitions from the darkened zone 103 to the illuminated zone 105 every minute, then a maximum total of 1440 transitions (1 plant or cart/min.*60 min/hr.*24 hr.) occur in a 24 hour period, presuming a balanced 12 hour cycle in the illuminated zone 105, a 12 hour cycle in the darkened zone 103, and a conveyor 104 long enough to store said quantity of plants in containers 123. That means that for a batch of 1,440 containers 123 with plants, the batch could be processed for a single cycle, or lap, through CEAS 101, assuming a speed, or indexing rate, of conveyor 104 that matches a rate of transition section 151/152, and other stations. For slight mismatches in speed, buffers are build in, or position sensors will stop the progress of the conveyor 104 until a hold-up service station or transition section is available to accept an incoming container 123 with one or more plants. If all the plants in the CEAS 101 are desired to be in full illumination in one embodiment, with no time in darkened zone 103, then said plants would consume the full space in the illuminated zone 105 in one embodiment, and only a half batch, or 720 containers 123 with plants, could be accommodated in the illuminated zone 105 (given the sizing mentioned above for the balanced cycle). If the plants are desired to make two balanced cycles in light and dark zones within a 24 hour period, then the same quantity of plants can be handled as the first example, 1,440, if multiple speed of conveyor 104 and transition sections 151, 152 processing rate can be doubled, or if the length of the conveyor 104 is shortened routing through shortcuts via switches 108c, and 108m, with a commensurate reduction in quantity of plants handled. Thus, many different configurations of duty cycles, conveyor routing, and throughput can be accomplished with the reconfigurable CEAS 101.

In one embodiment, conveyor 104 runs a variable duty cycle 304 for at least one of the one or more plants disposed in the illuminated zone 105. In another embodiment, conveyor 104 runs continuously for at least one of the one or more plants disposed in the illuminated area or in the darkened zone. Conveyor 104 can move containers with plants in a wide variety of propulsion systems. Different duty cycles of illuminated zone 105 and darkened zones 103 can be tailored or adjusted on a plant-by-plant basis for different goals of blooming, flowering, budding, fruit-growing, seeding, leafing, etc.

Any means for transporting or moving plants in containers 123 between stations and between illuminated and darkened zones, so long as the means is reasonably consistent in continuous or indexed rate of motion, can support the weight of the plants, can deliver the plants with reasonable geographical accuracy. Examples of means for moving, or a mover, include one or multiple combinations of i) a electromechanical solenoid plunger 118 (electrical, pneumatic, or hydraulic) that pushes containers with plants for a given stretch ii) a mechanically driven conveyor with a motor/gear/chain drive; iii) a gravity powered conveyor with an angled conveyor and a lift section at the end of a length of conveyor to reset the height of the plant for the next gravity conveyor; iv) a waterway conveyor with a trough in which the plants float along from station to station; v) vertical and horizontal roller conveyor or racks; and vi) robots, each of which support one or a sub-batch of plants; and that moves to different service stations, thus being totally reconfigurable and routable for a given geographical location.

Additionally, the programmable route of conveyor 104 and/or the programmable position of transition sections 151, 152 can allow different duty cycles. For example, bypass sections 106a can shorten the effective path of conveyor 104 in illuminated zone 105 for a shorter time in said illuminated zone 105. Alternatively, extension section 106b adds effective path to conveyor 104 in illuminated zone 105 for a longer time in said illuminated zone 105. Similarly, bypass section 106d and extension section 106e in darkened zone 103 can shorten or lengthen the duration of time that container 123 with plants spend in said darkened section 103. Programmable switches 108a through 108d and 108k through 108p provide the routing control for which route containers 123 should take.

In another embodiment, a length of conveyor 104 is constant, but the position of transition sections 151, 152 is moveable and thus can be moved to shorten or lengthen a length of conveyor 104 in either illuminated zone 105 or darkened zone 103. A flexible diaphragm body and cover (not shown) are sealed around transition section 151, 152 and enables movement along conveyor 104 without comprising light security. Furthermore, switches 108e, 108f, can allow repeat laps in a given illuminated section 105 via route AA, while switches 108p, 108q, can allow a variable or constant repeat laps in a given darkened section 103 via route BB for a desired light/dark growing schedule. A programmable control of conveyor 104, is described in subsequent figures of server and mobile computing systems, controlling operation of switches 108a through 108q to route specific plants on any basis, e.g., an individual plant basis, a batch size basis, or on an entire crop basis.

The CEAS 101 also includes at least one sensor coupled to at least one service station in one embodiment. In other embodiments, at least one sensor is coupled to each and every service station or pairing thereof, while yet another embodiment has sensors attached to less than all service stations, e.g., less than 10% of the service stations not having sensors. The at least one sensor senses at least one of a unique identifier of the one or more plants, a visual condition of the one or more plants, a weight of the one or more plants, an elasticity of the one or more plants, a health of the one or more plants, a chemical effusion of the one or more plants, a reflectivity of the one or more plants, and any other condition, measurement, or inspection of a plant that would effectively determine its health, its strength, its growth stage, its percentile, its malady, its disease, its budding, its fruit bearing capability, or any other factor of value for the plant. In one embodiment, every service station has at least one sensor to determine the unique identifier of the container and/or plant, along with another optional sensor for determining the condition of the plant and the level of service applied. Sensors include, but are not limited to moisture/humidity sensor 232 (capacitive sensor insertable into soil or grow media), gas chromatography sensor 234, gas spectroscopy sensor 236 (using any type of laser, e.g., a quantum cascade laser (QCL), infrared sensor 238, ultrasonic sensor 239, camera and computer vision sensors 226, environmental oxygen/O2 sensor, environmental carbon dioxide/CO2 sensor (to enhance growth with measured supplemental CO2 levels), soil nitrogen/N sensor, soil Oxygen/O2 sensor etc., some of which are described in subsequent figures. Computing system 300/400 utilizes a processor (e.g., processor 402 shown in subsequent figure) to i) process data received from sensors sent as status input/feedback to, and ii) optionally provide instructions/status/prognosis of plants and their related machinery in CEAS 101 to a user or a manual/automated preventative maintenance (PM) system. Data is communicated between equipment (sensors, e.g., reader 122; transition section 151/152; conveyor 104; lighting area 156, 158, 159; etc.) in CEAS 101 via any medium (e.g., wired 166, wireless, fiber, line-of-sight, etc.)

Lighting areas 156, 158, and 159 are illuminated by respective light sources 156a, 158a, and 159a which are any combination of natural light (through selectably transparent windows 109) and artificial light such as high-pressure sodium (HPS), light-emitting-diode (LED) lighting, fluorescent, ceramic metal halide, plasma, etc. Boundary 157 can be a reflective translucent or opaque physical boundary (such as a curtain apparatus) that separates different lighting areas 156, 158, and 159. Alternatively, boundary 157 can be a virtual boundary, with no real physical boundary. In this embodiment, an effective boundary is created by controlling light intensity and by steering light patterns to keep them within a given section, e.g., 156, 158, and 159. Thus, for example, by angling lights 158a and placing adjustable reflective panels on the output of the lights, some control on directionality of the light can be accomplished. Alternatively, using some overlap of lighting from different areas, e.g., from 158 and/or 159 to area 156, can simulate a desired light pattern. Thus, for example, sections 156, 158, and 159 can represent a morning, afternoon, and evening lighting pattern, respectively, in terms of light intensity, direction and/or spectrum best suited to the growing, maturing, fruiting regimen desired for the given plants. A morning section 156 can have angled lighting 156a striking the plants from the side, or can use reflected or diffused light from another more intense section, e.g., afternoon overhead light source 158a, to supply a lower intensity morning light condition. Alternatively, lighting can be provided from a wide variety of angles, including having all lights suspended from above the plants.

A unique identifier for plants or containers 123 could be a QR code, a bar code, an RF ID tag, an optical sensor, or a computer vision with image recognition to tag a given plant with an identifier. An RF ID tag reader/interrogator 122 is shown in at least one single location in the present figure. Alternatively, reader/interrogator 122 could be located in multiple locations on conveyor 104, especially at junction points like 108a through 108q, but also at service stations in different embodiments in order to confirm the condition of and the service provided to a given plant. Data from reader/interrogator 122 is sent as status input/feedback to, and for receiving instructions/status/prognosis/from, computing system 300/400 via communication link 166. Junction points 108a can be a gated section of conveyor 104 that directs the plant straight or on an angle, or can be a rotating table that directs a plant to a given route on conveyor 104.

CEAS 101 also includes a computing system 300/400 that can be a local PC, a cloud-based server, a wireless mobile device, or an edge-computing platform. Computing system 300/400 includes a database memory to receive the input from the one or more sensors relating to at least one of the one or more plants, and a processor to instruct the at least one of the service stations to deliver a plant-specific service depending upon data from the sensors. Computing system 300/400 uses tools such as machine learning (ML), deep learning (DL), artificial intelligence (AI) based on data set gathering, inference engines (Bayesian, Hidden Markov, etc.) and other statistical and predictive tools (e.g., Kalman filtering) to provide instructions/status/prognosis to CEAS 101. More detail on these computing solutions is provided in subsequent figures.

The programmability and configurability of conveyor 104 length and path, service stations applications, and time in illuminated zone 105 and darkened zone 103, combined with sensors to uniquely identify plants in containers 123 (via RF ID tag reader/interrogator 122) enables a mixed/heterogeneous simultaneous cultivation of same or different types of plants and same or different growth stages within CEAS 101. This includes intermingling of i) types of plants (flowers, vegetables, herbs, fruits, grass, roots, shrubs, etc. (“Crops”), interleaving of ii) different growth stages of the same or different crops; interspersing Crops having iii) different purposes (flowering, budding, fruiting, etc.); and iv) other characteristic differences other than a homogenous cultivation.

When a given plant is desired to be purchased or transported out of CEAS 101 for market, switches 108c and 108d route the plant to exit rack 132 for removal, per identification of plant ID by service station 112. Exit rack 132 is a vending machine interface in one embodiment, where a consumer can rotate stock in CEAS 101 to select a desired plant or produce via a viewing window, and then have the product delivered immediately at a dispensing window or shelf. This allows continuous partial harvesting of Crops in CEAS 101, including partial and selective fruit and/or vegetable harvesting of a portion of the ripe fruit and/or not the unripe fruit or vegetables of the plants, with the option that the plant having unripe fruit or vegetables remains in CEAS 101 for future harvesting of said unripe fruits/vegetables when they become ripe. Similarly, whole individual plant harvesting on a granularity basis of less than the entire population of plants, or less than a given batch of a plurality of plants, in CEAS 101, (e.g., a single plant granularity) is possible with the current system. The balance of the plants continues their cultivation in CEAS 101. This permits an on-site CEAS 101 system local to a grocery store or consumer point, on a fruit-by-fruit or plant-by-plant basis, rather than a single-event mass harvesting of all fruit or plants, thereby enabling a continuous fresh crop of plant-ripened produce. This system provides a capability for staggered growth, blooming, fruiting, and vine ripening of plants.

Table 1.1 provides an exemplary Crop schedule for operation in CEAS 101, with different types of crops including, for example, a tomato vegetable plant at 80% maturity, a tulip flower at 90% maturity, a couple of herbs of rosemary and parsley both at about 85% maturity, a couple of tobacco plants with one at 30% maturity and another at 50% maturity. The combinations and scheduling of different crops is limitless, depending primarily upon the desired application and needs of purchasers. Thus, with sufficient lead-time, and purchase patterns, mated with Crop growth characteristics, the delivery system can be essentially deterministic with a high degree of probability and a high degree of Crop utilization and reduced waste from overproduction of unwanted produce.

TABLE 1.1
Crop Schedule

| | | % | | Hrs | Hrs | Special | |
|---|---|---|---|---|---|---|---|
| ID | Plant Type | Stage | Station Seq | Day | Dark | Instruction | Comment |
| 123-A | VEG- | 80% | ALL; xtra | 14 | 8 | prune to | |
| | TOMATO | | H20 | | | single stem | |
| 123-B | FLOWER- | 90% | ALL; except | 4, | 5, | | |
| | TULIP | | no Pesticide | 4, | 3, | | |
| | | | or Herbicide, | 4, | 3 | | |
| * * * | | | | | | | |
| 123- | HERB- | 85% | ALL, mist | 6, | 2, | Filter light to | |
| AZ | ROSEMARY, | | water, | 6 | 2, | 50% | |
| | | | | 6 | 2 | | |
| 123- | PLANT- | 30% | ALL, mosaic | 12 | 12 | remove | |
| BA | TOBACCO | | virus ck | | | buds | |
| 123- | PLANT- | 50% | ALL, mosaic | 24 | 0 | | |
| BB | TOBACCO | | virus ck | | | | |
| * * * | | | | | | | |
| 123- | SEEDLING | 5% | Light Water - | 8 | 8 | | |
| DA | TOMATO | | diffuse light | | | | |
| 123- | SEED | 1% | Light Water - | | | | |
| DB | flower | | diffuse light; | | | | |
| | | | no pesticide | | | | |
| * * * | | | | | | | |

Referring now to FIG. 1B, an isometric view is shown of the exterior of the facility for controlled-environment agriculture system, according to one or more embodiments. Dark zone 103 is in the top part of the structure, while the lighted zone 105 is in the lower portion. Skylights and side windows provide natural light sources, along with artificial lights. This view is intended to aid the viewer understand the two-dimensional layout of FIG. 1A. Section line indicates the building can be as large or small as desired, for a given volume of plants. As it appears, the floor space can be nearly fully utilized, with minimal walkways for servicing by technicians. Multiple levels of conveyors and plans can be accommodated in the facility 101-B, depending on the height of the room and the expected height of the plants.

Referring now to FIG. 2A, a water service station 200-A is shown for a controlled-environment agriculture facility, according to one or more embodiments. Station 200-A includes an optional moisture/humidity sensor 232 (capacitive sensor insertable into soil or grow media) prior to water dispensing in order to provide an accurate baseline for plants' need. Station 200-A also includes a fixed rail of water dispensers 206a and a locally moving structure of water dispensers 206b. Local moving structure 206b can move in one or more directions (laterally, forward, rotationally, etc.) as well as pivoting water dispenser heads. Water can be provided as one or more of a spray onto the leafy surfaces, a pouring, or dispensed by a hose to the top soil (or any of various types of grow media) of the container housing the plant. Means for watering plants can be any plumbing arrangement that dispenses water in an amount and at a time appropriate to be timed for a given unique plant based on its identifier.

In one embodiment, station 200-A can be water-only dispensing. In another embodiment, a similar station to 200-A can provide pest-control chemicals and/or nutrients, with water as the medium if water soluble, or without water if not water-soluble. These stations can be dispersed in different locations around CEAS 101 as best suited for application time, duration, frequency, and amount. For example, pest control chemicals such as pesticides, herbicides, fungicides, etc. can be dispensed. Similarly, minerals and/or elements such as carbon, hydrogen, oxygen, phosphorous, potassium, nitrogen, sulfur, calcium, iron, and magnesium (sometimes referred to by the mnemonic ‘C. Hopkins Café, Mighty Good’ for macronutrients elements) Iron can also be dispensed as a micronutrient.

The unique identifier code is shown as a unique QR code for each container and/or plant as read by reader/interrogator 122. As shown by arrows, each water head can be directed to a different plant, or they can be pulsed as the plant is under or in the proximity of each head, with only a fraction of the sprinkler heads selectively dispensing in one embodiment, depending upon the QR code of the plant, and the database instructions from computer systems 300/400 for that given plant.

Plants in container 123 can travel continuously through a station at a given speed, or can be indexed at a given index rate into a static location in service station. If a set of plants are indexed into the water service station 200-A, then each of the sprayer heads can be tuned for a plant that is in its watering path, and thus water the sub-batch of plants that is capable of fitting in water service station 200-A. The rate of the sprinklers can be the same or tuned to a specific plant with a specific need based upon its growth state, status and health, and growth regimen desired. If a set of plants is continuously moved through the water station, then the water heads can be phased to match the travel of a plant (phased delivery). For example, if a lead plant 123-A enters station 200-A, a rightmost water sprinkler dispenses a quantity of water for the lead plant. Then as the lead plant moves forward and under the next sprinkler head, the first sprinkler head changes its dispensing rate to an amount appropriate for the second plant, which is now disposed beneath it, while the second sprinkler head from right will be instructed to dispense an amount/rate of water that is appropriate for the lead plant. This procedure continues as each plant moves through the station and under new sprinkler heads.

Containers 123 can provide a wide range of grow medium in which plants grow. Solutions include i) aquaponics as shown in container 123-A filled with water; ii) airponics via aerated and porous container 123-B as an oxygen-rich environment with a feeding service station that mists their roots with nutrient solution (from the top or bottom of the root system); iv) a hybrid medium, such as an open cell foam that transports water with nutrient solution; v) traditional soil medium with topsoil, vermiculite, compost, and/or other biodegradable contents; or vi) any of a wide range of grow media used in the industry. Sloped trays with rockwool, or basalt, can be used for a growing medium support as well.

Solenoid advancing mechanism 118 pushes the containers of plants forward to the next station or next turn on conveyor 204 in the present embodiment. The stroke of electromechanical solenoid plunger 118 provides an index into a given station length, with each adjacent container 123 providing the ‘bump’ movement to its adjacent neighbor.

Containers 123-A through 123-E are arranged in trays 124 or on wheeled carts (in lieu of a roller conveyor) in different embodiments for convenient transports from service station to service station. Carts can be wheeled by casters, omni-wheel, Mecanum-wheels, etc., that allow movement in two or more directions, so as to allow for transport around corners or at right angles, as shown in FIG. 1. Wheels can be guided down a path by a groove, channel, or rail on which they fit in, or ride on, respectively. Rails can alternatively guide carts, etc. along the programmable routes on which they will proceed. Carts can be self-propelled or externally propelled. External propulsion can be a plunger 118 or similar method of advancing or indexing trays 124 or carts. By a domino effect, an end tray 124 or cart is propelled or translated, which in turn translates the balance of the carts or trays in front of the end tray 124 or cart. Corners or curves are accommodated by having plungers pushing in different directions, e.g., orthogonally for a square corner, etc. Alternatively a continuous drive could be a tow chain, tow rope, tow cable, etc. onto which carts can be selectively clamped for propulsion. Alternatively, or in combination, a ceiling conveyor can also transport plants, as suspended by cable, rope, etc. By having a conveyor of trays, or a track for carts, that operate in parallel, nearly all the floor space can be occupied by plants, with minimal walkways for technical servicing of equipment. This approach achieves nearly 100% usage of floor space for better return on investment for operational expenses.

As shown, the present programmability and configurability of service stations, combined with sensors that uniquely identify plants (RF ID tag reader/interrogator 122) enables a mixed/heterogeneous simultaneous cultivation of plants e.g., 123-A thru 123-E, within CEAS 101, including different i) types of plants (flowers, vegetables, herbs, fruits, grass, roots, shrubs, etc.), ii) different growth stages, iii) different purposes (flowering, budding, fruiting, etc.); and iv) other characteristic differences other than a homogenous cultivation.

Referring now to FIG. 2B, a computer vision (“CV”) service station 200-B is shown within a controlled-environment agriculture facility, according to one or more embodiments. Computer vision service station 200-B service station is programmable on a plant-by-plant basis, per a unique identifier code is shown as a unique QR code for each container and/or plant, e.g., 123-F thru 123-H, and as read by reader/interrogator 122. Though a CEAS 101 is a controlled environment and typically located inside a building, which reduces the chance of pests, insects, fungi, and other plant diseases, these conditions can still arise. Thus, computer vision service station 200-B will examine plant leaf, stem, and soil or grow media color, reflectivity, consistency, contrast, uniformity, brightness, etc., on a per-plant basis to detect plant health or plant damage 208 (like rust, fungus, virus, leaf curl, leaf damage, etc.) and pest detection 209 (beetle, worms, aphid, etc.) with levels of infestation and possible vector source of same, given the historical recordation of plant pictures and data. Resulting data is communicated to computer system 300/400 for subsequent treatment at an appropriate service station (application of fungicide, herbicide, pesticide, or discharge of plant for disposal or inspection by technician, etc.). Computer vision service station 200-B can also detect a quantity of plant foliage, and a size and shape of plant stems and leaves, as well as plant elasticity. Elasticity of a plant can be detectable by a rate of movement of the plant vis-à-vis movement of the conveyor (e.g., a stop, start motion). Elasticity is a useful metric for hydration and health of the plant.

Service station functions of seed detection, bud detection, fruit detection, height detection and measurement, gender sensing, and many other visual metrics of plant health can be accommodated by a single or multiple specialized Computer vision service station(s) 200-B. To provide one or more of these functions, a learning or training operation of image datasets are acquired for artificial intelligence implementation of said specific functions of seed detection, bud detection, fruit detection, height detection and measurement, gender sensing, and many other visual metrics of plant health. Specific sensors of gas chromatography sensor 234, gas spectroscopy sensor 236 (using any type of laser, e.g., a quantum cascade laser (QCL), infrared sensor 238, ultrasonic sensor 239 can be piggy-backed to any given service station, e.g., computer vision station 200-B, or can be a separate station by themselves, individually or in appropriate groups.

In one embodiment, camera 226-A and/or 226-B utilize light detection and ranging (Lidar) to measures the distances to and/or shapes of leaves, stem, fruit, vegetable, foreign matter (insects, etc.) (together, the Vegetative Subject) of a given plant. Algorithms operated on a process can utilize this data to calculate plant mass, volume, density, and yield of fruit, vegetables, leaves, etc. Unlike some applications that filter out reflections from vegetation, the present application filters out other background images and surrounding equipment to measure the reflections from the Vegetative Subject itself to form the point cloud model. That model is then used to create a digital surface model (DSM) which represents said accurate state of the Vegetative Subject. The Vegetative Subject is illuminated with a pulsed laser light, with the reflected pulses being measured by a sensor. Differences in laser return times and wavelengths are used to create digital 3D representations of the target, matched with digital images to render a realistic looking 3D model. Points in a point map can be colored with a color from a pixel obtained from a same angle as an angle used by the laser that created the point. This creates a more realistic 3D model of the Vegetative Subject. Either one or two cameras for Lidar 226-A and 226-B can be used depending on the scope, coverage, and oversampling of the Vegetative Subject desired. The application typically used is a stationary terrestrial scanning, with the Vegetative Subject coming to a stop for the procedure. In another embodiment, the Vegetative Subject is moving, with the Lidar system adapted to capture moving images of the Vegetative Subject. The Lidar can be any type of laser and scanning apparatus including at least one of i) a rotating mechanical mechanism (interior rotating mirror to spread out the laser ray to cover a given field of view for the Vegetative Subject); ii) a phased array of laser sources that can accomplish the same task as a solid-state device with less mechanical maintenance; iii) 1 dimensional (1-D) micro-electro-mechanical (MEMS) scanning mirror for scan a laser beam into a single line or a two-dimensional pattern; and iv) a combination of the former embodiments with other lasing sources. With tuned precision, the Lidar can be used to select and scan for foreign objects such as insects, and unhealthy plant features such as leaf damage from insects, rust, mold, dehydrated leaf curl, or other plant conditions that are not expected, or are undesirable, for a given plant's age, status, and growth or yield regimen.

Alternatively one or more cameras 226 can be any combination of B&W, color, infrared, ultraviolet, etc. as best suited to determine plant health and productivity (seeds, fruit, etc.). In one embodiment, this camera data is fed to computing system 300/400, where augmented reality (AR) can overlay performance, sensor, and measurement data over an image of the plant in question, thus pairing the plant with its history, past performance, prognostics, etc. This composite picture can be presented to a remote viewing entity for decision making, intervention, management, services delivery adjustment, etc. on mobile device display 318 (which can be boxed in a viewing goggle for interactive management of plants). Multiple cameras are utilized in one embodiment for depth perception and composite image construction. In one embodiment, probes and/or instruments (trimming, probing, etc.) such as 232 from FIG. 2A offer interaction with given plants through the AR system. In this manner, manual walking around an entire warehouse of plants is not required to identify outliers, such as outstanding plants (for good example regimens to follow) or to identify failing plants (as poor example regimens to be avoided). Instead, the plants come to the camera station and this is then fed to a horticulturalist managing the system remotely to view the outliers, and execute corrective actions or process improvements. A force multiplier of a horticulturalist's experience and judgment is thus obtained with the present CEAS 101 solution.

Referring now to FIG. 2C, a weight-measurement service station 200-C is shown within a controlled-environment agriculture facility, according to one or more embodiments. Weight-measurement service station 200-C is programmable on a plant-by-plant basis, per a unique identifier code as shown by a unique QR code for each container and/or plant, e.g., 123-J thru 123-L, that is read by reader/interrogator 122. Weight sensor 240 provides analog and digital visual output as shown, and provides signal output of weight data to a database in a computer system.

The same concepts provided in FIGS. 2A-2C can be applied to many different types of service stations, as mentioned in FIG. 1, including, but not limited to, a watering service station, a camera service station, a measuring service station, a chemical application service-system (pesticide, herbicide, fungicide, etc.), a fertilizer service station, a pruning service station, a weighing service station, a gas analyzer service station, a gas spectroscopy service station, a gender-sensing service station, a seed-detection service station, a fruit detection service station, an elasticity testing service station, a computer-vision service station, an extraction service station, a harvesting service-station, and other service stations used for cultivation, though not shown in the current figures for sake of brevity.

Referring now to FIG. 2D, a floor plan 200-D is shown of a cart-system for growing plants in a controlled-environment agriculture system, according to one or more embodiments. FIG. 2D is similar to FIG. 1A, but with a movable cart system instead, has both a dark zone 103 and an illuminated zone 105. In lieu of a conveyor, carts 252 with a matrix of plant types on each move through a labyrinth with multiple service stations, e.g., service station 110-B (most other service stations not shown for clarity of the figure). Each cart 252 can have any combination of type of plant and growth stage. For simplicity of this illustration, all plants are a same type at a same growth stage. Movers in the form of pneumatic, hydraulic, or electrical plungers, pistons, solenoids 118 push an end cart, which then propels any other cart in front of it by a domino effect, thanks to front and back bumpers 256. Carts move in a lateral direction from plungers 118-A. Omni-direction or Mecanum wheels allow the carts to propel in a straight motion in channels disposed in a floor, or a rail, which fades away to a smooth surface for an up down movement by plungers 118-B, which said omni-directional or Mecanum wheels also accommodate. Overhead lighting (not shown for clarity) provides artificial light from any typical light source used for agriculture. Transition zones 151 and 152 prevent communication of light from illuminated zone 105 to darkened zone 103. An ingress and egress port exists similar to FIG. 1, but is not shown for sake of clarity. Side rails 260 can also be used to keep carts 252 guided along an appropriate path. For changes in pathways, a turnstile-like transition zone 152 is used, with variable angles of rotation, e.g., 90, 180, 270, to direct the cart to the appropriate path.

Referring now to FIGS. 2E-2F, floor plans 200-E and 200-F, respectively, are shown of a cart-system for growing plants in a controlled-environment agriculture system with labyrinth doors for transition between dark zone 103 and illuminated zone 105, according to one or more embodiments. By using a series of lightproof doors for both transition directions (light→dark, and dark→light) that do not allow transition of more than 1% light in one embodiment, or 5% light in another embodiment, a successful transition between the two zones occur, without light contamination of plants in the dark zone 103. Doors can be vertical or horizontally operated. Carts with wheels are pushed, or self-propelled (or conveyors that butt up against each other with a break at a door location) to a transition zone between the first door and the last door. Sides of doors have rubber gaskets, or a rubber flange curved with a friction pressure (like one or more squeegee(s)) against the door to prevent communication of light. As shown in FIG. 2E, the door sequence is Closed-Open-Closed for both transition zones, in order to move a cart into the new zone (from non-illuminated to illuminated and vice versa). In FIG. 2F, the door sequence is Open-Closed-Open for both transition zones, in order to move a cart within its given zone, and prepare it for the next move to the new zone (from non-illuminated to illuminated and vice versa). Other routes and embodiments for moving carts through a labyrinth or maze of services are contemplated by the present disclosure. Service stations are omitted for clarity of the purpose of the figure, which is to show the movement of carts, and plants thereon, thorough CEAS 200-E and 200-F.

While it is not possible to achieve 100% sealing of light, by using multiple series of doors, the probability and quantity of light transmitted to a non-illuminated zone 103 is decreased. Thus, while three sequential doors are shown in both figures for both transition directions, another embodiment utilizes four, five, or six doors. If each successive door only allows 5% of light, then the resulting cumulative light transmission is X\hat{ }Y, where X is a percent reduction and Y is the quantity of doors. For example, for four doors with 10% transmissibility each, in the closed position results in a net transmission of light=(0.1\hat{ }4)=0.01% net light transmission). A cart is moved through an open door into an open slot. With the exception of these open slots, the entire floor space of a given growing area can be utilized. By reducing the size of the carts, the size of the open slot then reduces as well, approaching nearly 100% floor utilization of growing area. The trade-off is the use of smaller carts, which might require more frequent, though smaller, propagation strokes (from a solenoid, or other mechanism to advance a cart along the route) the smaller the granularity of the tray, the less wasted space. Mathematically, utilization of grow space or area is (N−1)/N, where N=qty of carts fit full pack in given space. Thus, if only three carts can fit with one open slot for a grow area as large as four carts, then floor utilization is 3/4=75%. Alternatively, if 99 carts can fit with one open slot for a grow area as large as 100 carts, then floor utilization is 999/1000=99%. By utilizing multiple vertical layers of conveyors (or carts) as discussed in previous sections, a floor utilization rate of greater than 100% can be achieved. For example, if 4 layers are utilized, then a 396% utilization ratio can be achieved (99%×4 in a 99 cart system). Higher utilization ratio lowers the operating cost of a CEAS, and hence the cost of the produce it creates.

### Computing Systems

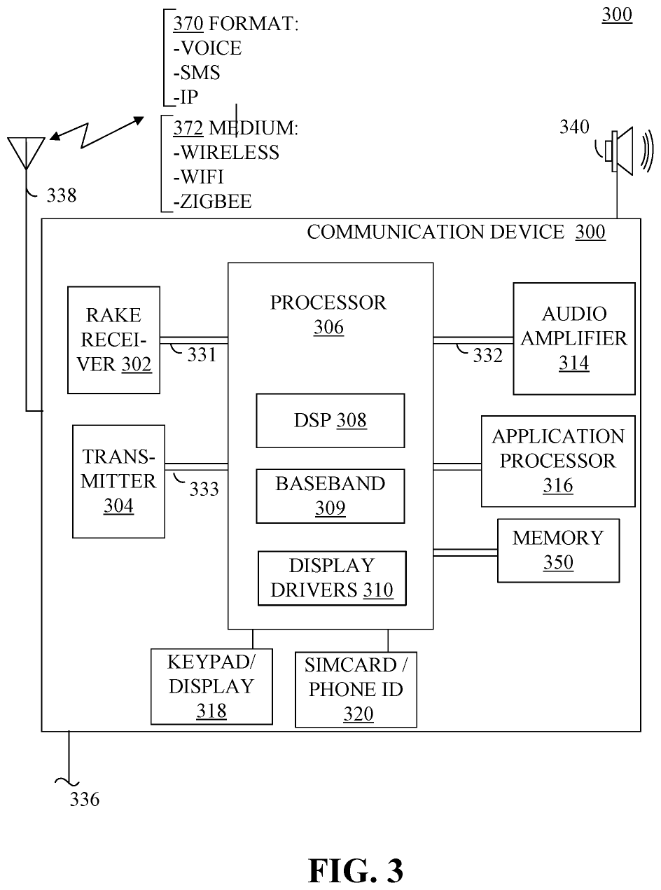

Referring now to FIG. 3, a mobile device 300 is shown for receiving data and transmitting instructions to a controlled-environment agriculture system, according to one or more embodiments. Mobile device 300, aka a personal communication device such as a cell phone, tablet, smart watch, smart ring, etc. includes a rake receiver 302 to receive signals from antennae 338 and communicate both the voice and dual tone multiple frequency (DTMF) 331 to processor 306 with digital signal processing (DSP) 308, which provide the CODEC/MODEM, and other signal processing functions. Alternatively one or more signals may be provided by wired connection 336, such as Ethernet, coaxial, or optical cable, etc. Processor 306 includes a baseband processor 309 configured to provide recognizable voice output 332, voice recognition modules, or DTMF tones to audio amplifier 314, coupled thereto. This can be implemented in one of multiple methods. SIM card/caller identification block 320 provides the identification features used by an entity accessing mobile device 300, via transmitter 304 and antennae 338 or cable 336, to verify the identity of the user. Keypad/display 318 coupled to baseband processor and application processor allows the user of mobile device 300 to input data and instructions to configure the system and control parameters as needed.

Processor 306 is used to process data from sensors including, but not limited to, reader/interrogator 122, weight sensor, moisture/humidity sensor, gas chromatography sensor, gas spectroscopy sensor, infrared sensor, ultrasonic sensor, camera and computer vision sensors, etc. on a plant-by-plant basis and compare to database percentiles. Additionally, processor 306 is used to process said data using tools such as machine learning (ML), deep learning (DL), artificial intelligence (AI) based on data set gathering, inference engines (Bayesian, Hidden Markov, etc.) and other statistical and predictive tools (Kalman filtering) to provide instructions/status/prognosis to CEAS 101 on a plant-by-plant basis, via wireless antenna 338 or wired connection 336 to service stations and/or sensors. Processor 306 in one embodiment includes a neural network portion for simulating artificial intelligence, or a quantum computing capability for simulating complex interactions of growth metrics and variables.

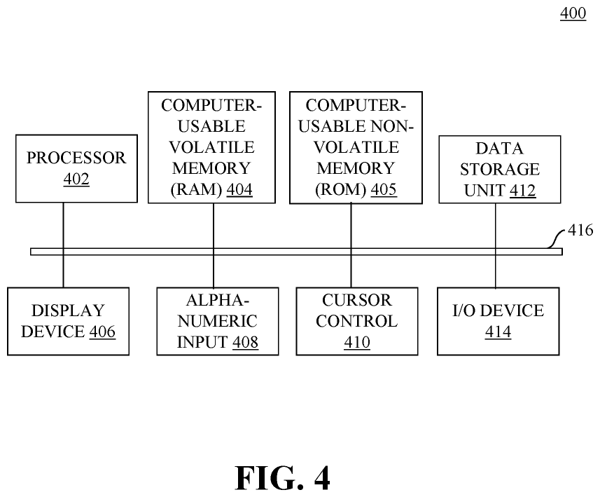

Referring now to FIG. 4, a computing system is shown for receiving data and transmitting instructions to a controlled-environment agriculture facility, according to one or more embodiments. Exemplary computing device 400 includes components and functionality that can be applied to several devices in a host system such as a personal computer, minicomputer, mainframe, server, and cloud-based resources, each of which are capable of executing instructions to accomplish the functions and operations described herein. Computing device 400 includes components such as a processor 402 coupled to a memory 404, 405, and/or storage 412. In particular, processor 402 can be a single or multi-processor core, for processing data and instructions. Memory 404, 405, and/or storage 412 are used for storing and providing information, data, and instructions, including in particular computer-usable volatile memory 404, e.g. random access memory (RAM), and/or computer-usable non-volatile memory 405, e.g. read only memory (ROM), and/or a data storage 412, e.g., flash memory, or magnetic or optical disk or drive. Computing device 400 also includes optional inputs, such as i) an alphanumeric input device 408, e.g. a keyboard, or touch screen, with alphanumeric function keys for object driven menus; ii) a keypad button; iv) a microphone with voice recognition software running on processor 402 or any device allowing a player to respond to an input; v) an optional cursor control device 410, e.g., a roller ball, trackball, mouse, etc., for communicating user input information and command selections to processor 402; vi) an optional display device 406 coupled to bus 416 for displaying information; and an optional input/output (I/O) device 414 for coupling system with external entities, such as a modem for enabling wired or wireless communications between a system and an external network such as the Internet, a local area network (LAN), wide area network (WAN), virtual private network (VPN), etc. Coupling medium 416 of components can be any medium that communicates information, e.g., wired or wireless connections, electrical or optical, parallel or serial bus, etc.

The computing device is only one example of a suitable computing environment and is not intended to suggest any limitation as to the scope of use or functionality of the present technology. The client sensors and service stations can be smart devices (e.g., Internet of Things, IoT, devices), with sufficient processors, memory, graphics, and input/output (I/O) capabilities to operate their respective portion of the software. Alternatively, client sensors and service stations can be a thin client, e.g., a dumb device, which only has a capability or is only used to a capability of displaying results and accepting inputs or sending sensor data. Neither should the computing environment be interpreted as having any dependency or requirement relating to any one or combination of components illustrated in the exemplary computing system. The present technology may be described in the general context of computer-executable instructions, including program modules, executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer-storage media including memory-storage devices, e.g., server farms and databases disposed in the cloud.

Processor 402 has a description and function that is essentially the same as that provided for processor 306, save any functions appropriate only for a mobile device. similar to processor 306 in the prior figure, is used to process data from sensors including, but are not limited to, reader/interrogator 122, weight sensor, moisture/humidity sensor, gas chromatography sensor, gas spectroscopy sensor, infrared sensor, ultrasonic sensor, camera and computer vision sensors, etc. And processor 402 is used to process said data using tools such as machine learning (ML), deep learning (DL), artificial intelligence (AI) based on data set gathering, inference engines (Bayesian, Hidden Markov, etc.) and other statistical and predictive tools (Kalman filtering) to provide instructions/status/prognosis to CEAS 101 via wireless antenna 338 or wired connection 336 to service stations and/or sensors.

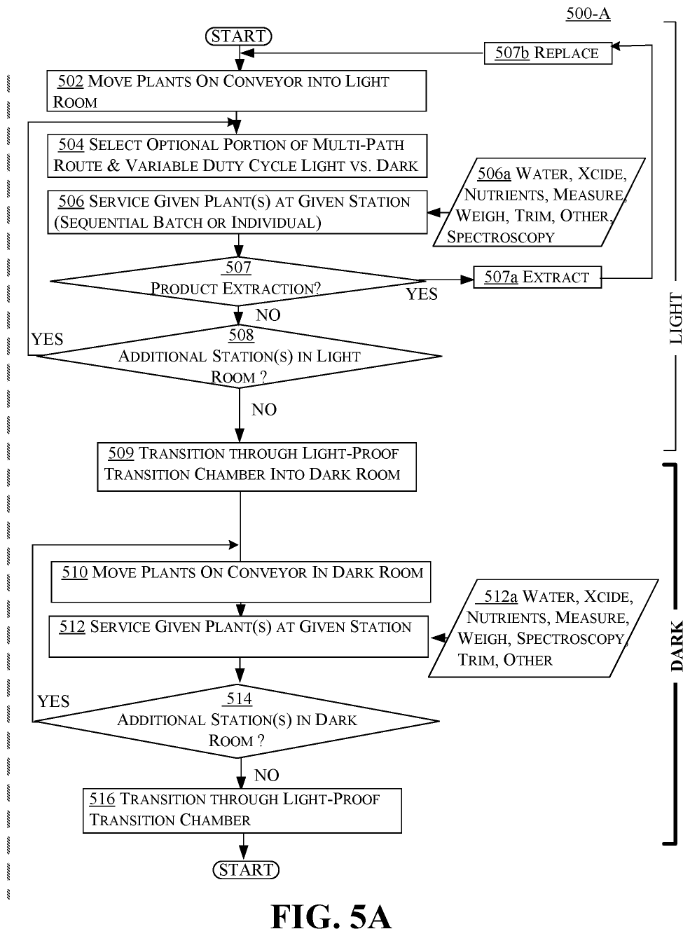

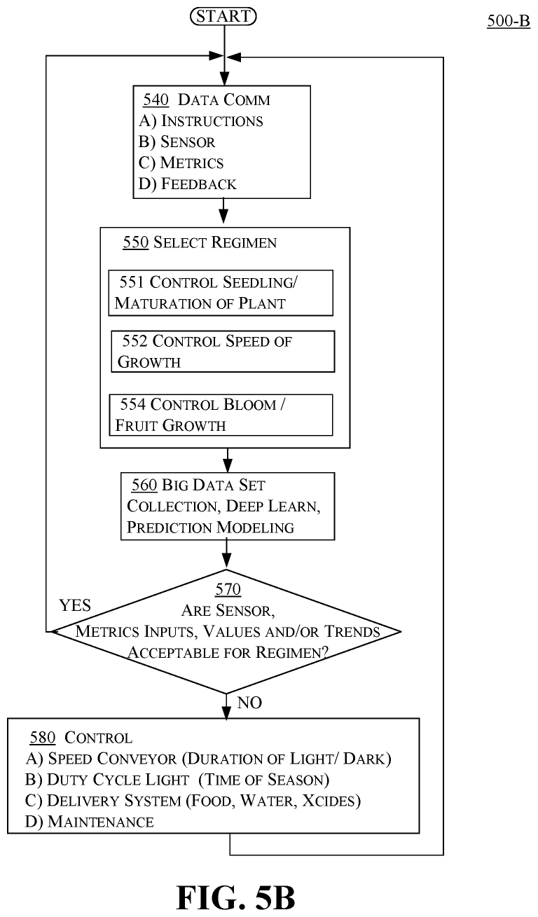

Referring now to FIG. 5A, a method 500-A is shown for servicing plants and managing time cycles in light and dark zones in a controlled-environment agriculture system, according to one or more embodiments. Method 500 is implemented in apparatus and system FIGS. 1 through 2C and is controllable by processing systems in FIGS. 3 to 4.

In operation 502, plants are moved on conveyor into an illuminated light room, either as fresh new seeded pots, seedlings, or plants via input/output interface 132, or as in-place plants that are conveyed out of a darkened zone 103 into illuminated zone 105 via transition section 151. Plants can be loaded or introduced into CEAS 101 as single plants (e.g., to replace a single plant that was extracted therefrom), as a batch or sub-batch of plants. In addition, plants can be at a same or different growth state (seeded plant, seedling, etc.) regardless of any states for the balance of plants already disposed in CEAS 101. In addition, any mixture of plant types (such as vegetables, herbs, fruits, flowers, etc.) can be loaded into CEAS 101 in any order. Unique identifier labels are used for plants and/or containers housing them (or detectable plant types via computer vision) in order to enable any combination of plant types and states and growing regimens to be managed by CEAS 101. Because the CEAS 101 is a smart system, having detectors, sensors, and computer-controlled operations with programmable levels of service station applications to each of the individual plants, a plant-by-plant granularity is feasible with the present method.

Operation 504 selects a desired route within multi-path route of CEAS 101 and selects a variable duty cycle in illuminated (light) versus darkened zones. This operation is possible by using switches 108a through 108f in illuminated zone 105, and switches 108m through 108q in darkened zone 103 which enable one of a plurality of possible routes, including a nominal routing (all service stations without route shortcut or extension), or shortcuts 106a, 106d, or extended routes 106b, 106e, or repeated cycles AA, BB. In one embodiment, a plant can loop back through illuminated zone 105 for as much time as desired, including an entire life of the plant. In another embodiment, a path parallel to 106b can be used as a quarantine section for plants needing additional service not provided by CEAS 101, such as health or infestation diagnosis.

Next, operation 506 services given plant(s) at a given station in a sequential batch or on an individual basis. Input 506a provides one or more services of water, pesticide/herbicide/fungicide/etc. (Xcide), nutrients, weight measurement, trim, spectroscopy, or other service appropriate for cultivation. For example, FIGS. 2A, 2B, and 2C can provide watering, computer vision inspection, and weighing services on an individual basis or on a batch basis, depending on how the computer controlled program instructs the service station and its specific components, which in turn depends on the plant type, status, need, prognosis, etc.

Operation 507 inquires whether product extraction is desired. The product extraction could be based upon a maturity level of the plant; a request by a consumer or distributor for a given plant or portion thereof regardless of state of the plant; a poor state/performance/disease of the plant; etc. Input is provided by either a program that determines the status of the plant for harvesting, or an input from i) a keypad 418 (touch screen) or voice recognition in application processor 416 mobile device 400; ii) an I/O device 414 in computing platform 400, or other method of communicating. Operation 507a extracts a given plant based on the plant unique ID matching the desired plant, and then processes the plant out of CEAS 101 via I/O rack 132. An optional operation 507b provides a replacement plant of a same or different type, depending on actual/forecast demand for future plant products.

Operation 508 inquires whether there are additional station(s) in light room through which a given plant is to receive services. If ‘yes’, then the plant can be routed to service stations desired, or if ‘no’, then a plant can be routed through a service station without the service being delivered, or the plant can be routed via a shortcut, e.g., 106a, or 106d to bypass only specific service stations. Additional services include additional exposure time to illumination, e.g., by looping a plant via return path AA back through the illuminated zone.

Operation 509 transitions plants through lightproof transition chamber 151 into dark room, or darkened zone, 103. Once there, operation 510 moves plants on conveyor 104 within the dark room 103, e.g., on conveyor 104, plants are then serviced by one or more service stations 114-A through 114-H, and 116-A, 116-B per operation 512, with service input 512a of water, Xcide, nutrients, measure, weigh, spectroscopy, trim, and other services as described herein. Data stored in 512 is also the database of results of machine learning and sensor gathering metrics including, but not limited to lighting, feeding, water, trimming, harvesting, etc. In this manner, vast quantities of data can be vetted for optimal growing conditions, given unique grow variables, environments, pest conditions, etc. for a given region of the world, a given hybrid or species of crop, energy-budget for lighting, HVAC, etc.

Operation 514 inquires whether a plant needs additional services from additional station(s) in dark room. If yes, then the computer controlled switches 108m through 108p and loop path BB are appropriately selected per the program, which is tuned to the specific type of plant and its status. In one embodiment, a plant can loop back through darkened zone 103 for as much time as required. If no additional operation is required, then operation 516 transitions the plant through lightproof transition chamber 152 back into illuminated zone 105, which is operation 502. Method 500-A repeats until a given plant is extracted. Method 500-A can be performed on a batch basis of two or more plants, but less than all plants, or on a batch basis of all the plants, or on an individual plant basis.

Referring now to FIG. 5B, a method 500-B is shown for controlling, gathering data, and providing feedback to improve plant growth CEAS 101, according to one or more embodiments. Method 500-B is implemented in apparatus and system FIG. 1 through FIG. 2C, and is controllable by computing, or processing, systems 300 and 400 in FIGS. 3 and 4 in conjunction with procedure of flowchart 500-A in FIG. 5A.

Operation 540 data communication includes, but is not limited to, outputting a) instructions (from computing system memory 404, I/O device 414, edge computing device(s) 222 on conveyor 104, etc.); b) data from one or more sensors (e.g., weight sensor, computer vision sensor, etc. sensors in CEAS 101); c) one or more metrics sources (from databases in computing system memory 404, sensor memory (in IoT 222), etc.); and d) data from one or more feedback signals (feedback to/from user input 414, computing system 300/400, sensors 226-240, etc.) to control operations performed by CEAS 101.

Next, computing system 300/400 or embedded edge computing 222 (e.g., IoT, embedded controller and memory) in sensors and service stations of CEAS 101 select one or more regimen 550 of i) operation 551 control seedling/maturation of plant, ii) operation 552 control speed of growth of individual plants, sub-batches, or batches thereof; and iii) operation 554 control bloom/fruit growth of plan. This operation can provide an initial start instruction setting for desired services at service stations and a desired growth cycle setting per output from operation 540, or as provided by a botanist, a horticultural specialist, a technician, or a baseline-programming model based on an initial learning stage of the given plants on the conveyor. So either the system is programmed with the start condition of the plants, or the system learns about the stage of the plants through weight sensor, computer vision/Lidar sensor, etc. (which said sensors could be disposed at the start point of new plant insertion into CEAS 101). This baseline input can be later modified based on noted sensor input, metrics measurements, and feedback from sensors and service stations in CEAS 101. This regimen operation 550 can change through the life of the plants in CEAS 101, either on a batch, sub-batch, or individual plant granularity basis. For example, all plants could be in a growth stage, except a minority of one or more plants that are interspersed therein on a regimen of control bloom or fruit growth.

Operation 560 performs big data operations such as data set collection, deep learning, and prediction modeling. Data provided from operation 540 and a selected regimen provided from operation 550 are entered into a database. Specifically, a database stored on storage unit 412 of computing systems 300/400 evaluates data received from operation 540 against a desired regimen selected in operation 550 for one or more of i) 551 control seedling/maturation of plant, ii) operation 552 control speed of growth; iii) operation 554 control bloom/fruit growth of plan.

Operation 570 inquires whether the data from 540 data communication operation when compared against the selected regimen from operation 550 is on par. For the analyses in this operation 570, different algorithms and deep learning to interpret the data and trends, will be used to help decide whether further modification to the CEAS 101 is required to provide optimum yield of the plant and optimum scheduling for harvesting. Again, processor 302/402 of computing systems 300/400 is tasked with this evaluation. User input can be used to validate and calibrate the expert system. Training operations of the method 500-B over time provides the system with an ever-increasing database knowledge to better tune algorithms and responses.

Deep learning and prediction modeling from operation 560 is provided to operation 580 as implemented by CEAS 101 in FIGS. 1 and 2A-2C. Types of data that are transferred include, but is not limited to a) conveyor speed and/or length (duration of light/dark) b) duty cycle, intensity, profile, duration, rate of change, etc. of a light source (and conversely duty cycle in dark, for the time of a given season) c) delivery system (food, minerals, elements, water, Xcides) from service stations; d) temperature, humidity, HVAC, and other environmental metrics; and e) maintenance, harvesting, etc. of plants, fruit, vegetables. The loop from 540 to 550 to 580 (via 570) and back up to 540 is a feedback system wherein operating conditions for the plants can change in operation 580 based on the sensors, metrics, and feedback received from operation 540 and communicated to operations 550 and 560 for processing by computing systems 300/400. Thus, if after start instructions are implemented, B) sensors in 540 subsequently communicate metrics, feedback, and other sensor data for a given one plant, or batch of plant types that are receiving too much light from in CEAS 101 (wilting, leaf curling, dehydration of plants, etc.), then operation 580 will evaluate this data and make adjustments as outputs from operation 580 to modify speed of conveyor 104, duration of light and dark exposure, intensity of light, light spectrum, delivery of water or nutrients, etc. When those new settings are implemented and continuous sensor data, metrics and feedback are generated over time in operation 540 from equipment in CEAS 101, which will be subsequently evaluated in an iterative loop through operations 550, 560 and 580, which reacts to those new results. Consequently, the feedback is continuously operating between 540, 550, 560, 570 and 580, with appropriate damping for given response times of equipment and plant physiology. Metrics and statistics of the time and light intensity duty cycle profile over time are available for cause-effect analyses and growth-recipe modification.

Overall, the present disclosure provides an efficient, flexible, and highly programmable CEAS with a granularity down to an individual plant within a huge collection of plants that can be interleaved, so to speak, with many different types of plants at different growth stages, and with different growth regimens. The result is an on-site (or in-store, like a bakery) facility for organically-grown produce system with i) less pollution than a typically transported produce from hundreds of miles away; ii) less chemicals from pesticides fungicides, etc. (b/c of the computer vision and highly-capable service stations with continuous monitoring and servicing of plants); iii) just-in-time (JIT) growth and delivery procedure for fresher, plant-ripened produce because produce can be partially or fully harvested from a given plant depending upon nearly real-time consumer demand with the remaining fruit remaining on the plant and in the growth system; iv) less floor space consumption in a store, because the rotating plants can be called up for fresh dispensing of produce on demand; and many other benefits; v) less wasted produce from overbuying, overproducing, damage from shipping, etc.; and vi) less infrastructure, because service stations can be flexibly rearranged on a conveyor system and have focused functions to which the plants are transported, rather than having infrastructure routed to every plant location. The database gathering of growth, yield, pest resistance, salinity tolerance, and any other cultivation-related metrics allows for benchmarking, critical cause-effect factor identification, and world-class growing techniques and yields, as well as design-of-experiments for optimizing growth and developing new hybrid plants and regimens among the many combinations and permutations (different sequences) of variables (e.g., different nutrition regimens, lighting, Xcide application, hybrid seed types, etc.). Specifically, the programmability, flexibility, and individual plant granularity of service station delivery mechanisms means that CEAS 101 is an ideal vehicle for Taguchi design of experimentation (“DoE”) in a small footprint, with accelerated results by running different experiments in parallel on a single CEAS 101 system.

CEAS 101 has safety guards and features for appropriate service stations, particularly hazardous ones such as the pruning service station, chemical delivery service stations, etc. which typically involves sharp instruments, toxic chemicals, etc., respectively, that could harm humans.

### REFERENCES

References to methods, operations, processes, flowcharts, systems, modules, engines, and apparatuses disclosed herein are implementable in any means for achieving various aspects, including being carried out by a hardware circuit or a plurality of circuits (e.g., CMOS based logic circuitry), firmware, software and/or any combination of hardware, firmware, and/or software, the latter being in a form of a machine-readable medium, e.g., computer readable medium, embodying a set of instructions that, when executed by a machine such as a processor in a computer, server, etc. cause the machine to perform any of the operations or functions disclosed herein. Functions or operations may include receiving, transporting, delivering, transferring, sensing, recording, instructing, measuring, detecting, and the like.

The term “machine-readable” medium includes any medium that is capable of storing, encoding, and/or carrying a set of instructions for execution by the computer or machine and that causes the computer or machine to perform any one or more of the methodologies of the various embodiments. The “machine-readable medium” shall accordingly be taken to include, but not limited to non-transition tangible medium, such as solid-state memories, optical and magnetic media, compact disc and any other storage device that can retain or store the instructions and information. The present disclosure is also capable of implementing methods and processes described herein using transition signals as well, e.g., electrical, optical, and other signals in any format and protocol that convey the instructions, algorithms, etc. to implement the present processes and methods. The memory device or similar electronic computing device manipulates and transforms data represented as physical (electronic) quantities within the devices' registers and memories into other data similarly represented as physical quantities within the devices' memories or registers or other such information storage, transmission, or display devices.

Exemplary computing systems, such as a personal computer, minicomputer, mainframe, server, etc. that are capable of executing instructions to accomplish any of the functions described herein include components such as a processor, e.g., single or multi-processor core, for processing data and instructions, coupled to memory for storing information, data, and instructions, where the memory can be computer usable volatile memory, e.g. random access memory (RAM), and/or computer usable non-volatile memory, e.g. read only memory (ROM), and/or data storage, e.g., a magnetic or optical disk and disk drive). Computing system also includes optional inputs, such as alphanumeric input device including alphanumeric and function keys, or cursor control device for communicating user input information and command selections to processor, an optional display device coupled to bus for displaying information, an optional input/output (I/O) device for coupling system with external entities, such as a modem for enabling wired or wireless communications between a system and an external network such as, but not limited to, the Internet. Coupling of components can be accomplished by any method that communicates information, e.g., wired or wireless connections, electrical or optical, address/data bus or lines, etc.

The computing system is only one example of a suitable computing environment and is not intended to suggest any limitation as to the scope of use or functionality of the present technology. Neither should the computing environment be interpreted as having any dependency or requirement relating to any one or combination of components illustrated in the exemplary computing system. The present technology may be described in the general context of computer-executable instructions, such as program modules, being executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer-storage media including memory-storage devices.

For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine-readable medium). Similarly, the modules disclosed herein may be enabled using software programming techniques. For example, the various electrical structure and methods may be embodied using transistors, logic gates, and electrical circuits (e.g., application specific integrated ASIC circuitry and/or in Digital Signal; Processor DSP circuitry; FPGA).

The present disclosure is applicable to any type of network including the Internet, an intranet, and other networks such as local area network (LAN); home area network (HAN), virtual private network (VPN), campus area network (CAN), metropolitan area network (MAN), wide area network (WAN), backbone network (BN), global area network (GAN), or an interplanetary Internet. Furthermore, the type of medium can be optical, e.g., SONET, or electrical, and the protocol can be Ethernet or another proprietary protocol.

Methods and operations described herein can be in different sequences than the exemplary ones described herein, e.g., in a different order. Thus, one or more additional new operations may be inserted within the existing operations or one or more operations may be abbreviated or eliminated, according to a given application, so long as substantially the same function, way and result is obtained.

As used throughout this application, the word “may” is used in a permissive sense (i.e., meaning having the potential to), rather than the mandatory sense (i.e., meaning must). Similarly, the words “include,” “including,” and “includes” mean “including, but not limited to” the listed item(s).

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. § 112, paragraph six, interpretation for that unit/circuit/component.

The foregoing descriptions of specific embodiments of the present disclosure have been presented for purposes of illustration and description. They are not intended to be exhaustive or to limit the invention to the precise forms disclosed. Many modifications and variations are possible in light of the above teaching without departing from the broader spirit and scope of the various embodiments. The embodiments were chosen and described in order to explain the principles of the invention and its practical application in the best way, and thereby enable others skilled in the art to best utilize the invention and various embodiments with various modifications as are suited to the particular use contemplated. It is intended that the scope of the invention be defined by the Claims appended hereto and their equivalents.

I/We claim:

1. A controlled-environment agriculture system comprising:
a mover for transporting at least one container housing one or more plants;
at least one service station for delivering at least one service to each of the one or more plants in the at least one container; and wherein:
the at least one service delivered by the at least one service station is provided in at least one of i) a sequential manner to another container disposed on the mover and ii) a parallel manner with at least one other service station disposed on the mover.

2. The system of claim 1 further comprising:
a transition section coupled to the mover, wherein the transition section separates an illuminated zone from a dark zone.

3. The system of claim 1 wherein:
the transition section prevents all effective light from passing therethrough that would otherwise disturb a growing cycle of a given type of the one or more plants.

4. The system of claim 1 further comprising:
wherein the at least one service station comprises at least one of:
a watering service station, a photo service station, a measuring service station, a chemical application service system, a fertilizer service station, a pruning service station, a weighing service station, a gas analyzer service station, a gas spectroscopy service station, a gender-sensing service station, a seed-detection service station, a fruit detection service station, an elasticity testing service station, a computer-vision service station, an extraction service station, and a harvesting service station.

5. The system of claim 1, wherein the station is at least one of a static and a locally-moveable fixture; and
the at least one container passes through the at least one service station to receive the at least one service provided therein.

6. The system of claim 1, wherein:
the mover runs a variable duty cycle for at least one of the one or more plants disposed in the illuminated zone.

7. The system of claim 1 wherein:
the mover runs continuously for at least one of the one or more plants disposed in the illuminated zone and in the dark zone.

8. The system of claim 1 wherein:
the dark zone is a blackout zone with less than 5% phyto-detectable light.

9. The system of claim 1 wherein:
the transition section is a door system that transports plant containers from the illuminated zone to the dark zone and that prevents more than 5% light passage from the illuminated zone to the dark zone.

10. The system of claim 1 wherein:
a continuous conveyor cycle is programmable to represent any duty cycle of time for exposing the plant containers to light and darkness for a desired growth pattern.

11. The system of claim 1 wherein:
the mover is a closed loop conveyor with a complete cycle to represent at least a pattern of at least one light cycle and one dark cycle for plant growth.

12. The system of claim 1 wherein:
the duration of time for the complete cycle changes over a growth lifespan of a given plant.

13. The system of claim 11 wherein:
the complete cycle is a programmable length of time, greater than or less than a 24-hour day.

14. The system of claim 11 wherein the mover is programmable to represent different light and dark duty cycles for different seasons of a year.

15. The system of claim 11 wherein:
an illuminated zone is illuminated for a continuous operation;
a dark zone is darkened for a continuous operation; and
the continuous operation is at least one of a nursery growth stage, a maturation growth stage, and a harvesting growth stage.

16. The system of claim 11 further comprising:
a plurality of service stations for delivering at least one service each; and wherein:
each of the plurality of stations operates in parallel with each other.

17. The system of claim 11 wherein:
the duty cycle is one of a synchronous, asynchronous, cyclic, continuous, and intermittent duty cycle.

18. The system of claim 11 wherein:
the plants move between the illuminated and the dark zones on a first-in-first-out (FIFO) basis

19. The system of claim 1 further comprising:
at least one sensor coupled to the at least one service station; and wherein:
the at least one sensor senses at least one of a unique identifier of the one or more plants, a visual condition of the one or more plants, a weight of the one or more plants, an elasticity of the one or more plants, a health condition of the one or more plants, a chemical effusion of the one or more plants, a reflectivity of the one or more plants.

20. The system of claim 19 further comprising:
a database memory to receive the input from the one or more sensors from at least one of the one or more plants; and
a processor to instruct the at least one of the service stations to deliver a plant-specific service depending upon data from the sensors.

21. The system of claim 1 wherein:
the service station is programmable on a plant-by-plant basis.

22. A method of growing plants in an agricultural-growing system, the method comprising:
transporting at least one container for housing one or more plants along a mover;
delivering at least one service to each of the one or more plants in the at least one container via at least one service station and wherein:
the service delivered by the at least one service station is provided in at least one of i) a sequential manner to another container disposed on the mover and ii) a parallel manner with at least one other service station disposed on the mover.

23. The method of claim 22 further comprising:
transferring the one or more plants between an illuminated zone and a dark zone via a transition section that separates the illuminated zone from the dark zone.

24. The method of claim 22 further comprising:
sensing data related to the at least one of the one or more plants via at least one sensor coupled to the at least one service station; and wherein:
the at least one sensor senses at least one of a unique identifier of the one or more plants, a visual condition of the one or more plants, a weight of the one or more plants, an elasticity of the one or more plants, a health of the one or more plants, a chemical effusion of the one or more plants, a reflectivity of the one or more plants.

25. The method of claim 24 further comprising:
recording data from the at least one sensor based on the unique identifier of each of the one or more plants into a database memory; and
instructing at least one of the service stations to deliver a plant-specific service for each of the one or more plants depending upon data received from the sensors and depending upon the unique identifier of each of the one or more plants.

26. An agricultural plant-growing system comprising:
means for transporting at least one container for housing one or more plants;
means for delivering at least one service to each of the one or more plants in the at least one container; and wherein:
the at least one service delivered by the at least one service station is provided in at least one of i) a sequential manner to another container disposed on the mover and ii) a parallel manner with at least one other service station disposed on the mover.
